(19) United States
(12) Patent Application Publication
(10) Pub. No.: US 2007/0222752 A1
(43) Pub. Date: Sep. 27, 2007

(54) Computer mouse

(76) Inventor: Wen-Pin Hsieh, Sijhih City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/499,796

(22) Filed: Aug. 7, 2006

(30) Foreign Application Priority Data
Mar. 27, 2006 (TW) 95110493

(51) Int. Cl. G09G 5/08

(52) U.S. Cl. 345/163

(57) ABSTRACT

A computer mouse is provided. The computer mouse includes at least a scroll wheel, wherein the scroll wheel includes: a plurality of openings and a plurality of lenses embedded in the plurality of openings separately. Another computer mouse is also provided, including at least a scroll wheel including at least a transparent means, wherein the transparent means includes a plurality of transparent parts and the transparent parts are formed within the transparent means. The lenses and the transparent parts mentioned above are utilized for the light for generating encoding signals of the scroll wheel to pass through.

### RELATED APPLICATIONS

The present application is based on, and claims priority from, Taiwan Application Serial Number 95110493, filed on Mar. 27, 2006, the disclosure of which is hereby incorporated by reference herein in its entirety.

### BACKGROUND

1. Field of Invention

The present invention relates to a computer mouse. More particularly, the present invention relates to a computer mouse with a scroll wheel.

2. Description of Related Art

On the modern market, the scroll wheel has become one of the necessities in the computer mouse. One of the common applications of the scroll wheel in the computer mouse is to apply to the wheel mouse 10. Please refer to FIG. 1. A lattice wheel structure is usually adopted by the scroll wheel 100. A plurality of lattices 100a are installed on the scroll wheel 100 and aligned along the inner circumference of the scroll wheel 100. The optical sensor 102 is installed at a side of the bottom of the scroll wheel 100, and the light emitters (not shown in the figures) are placed at the contrary side. As the scroll wheel 100 scrolls, the lights emitted by the light emitters pass through the lattices 100a one after another, and are received by optical detectors 102 one by one.

However, it is hard for the conventional design of the scroll wheel mentioned above to generate encoding signals of high resolution. It is necessary to increase the amount of the lattices 100a for raising the resolution of the encoding signals generated by the scroll wheel. That is, the size of the holes of the lattices 100a needs to be shrunk, which introduces the cost and the difficulty of fabrication inherently. Also, the structure of the scroll wheel becomes fragile while a huge amount of the lattices 100a are installed.

Further, when the lights generated by the light emitters passes through the small lattices 100a, the lights scatters. This causes the weak light signal detected by the optical detectors 102, and even the error encoding signals of the scroll wheel are generated in accordance.

Hence a computer mouse including a scroll wheel is introduced in the present invention for obtaining the scroll information of the scroll wheel more accurately in order to enhance the operation of the computer mouse.

### SUMMARY

The present invention is directed to a computer mouse that obtains accurate scroll information of the scroll wheel in order to enhance the control of the computer mouse.

The present invention is further directed to an improvement of the structure of the scroll wheel applied in the computer mouse, which is able to increase the resolution of the encoding signal of the scroll wheel.

It is therefore an aspect of the present invention to provide a computer mouse that includes at least a scroll wheel with a plurality of openings and a plurality of lenses.

It is another aspect of the present invention to provide a computer mouse that includes at least a scroll wheel with at least a transparent means.

In accordance with the foregoing and other objectives of the present invention, a computer mouse is provided. The computer mouse includes at least a scroll wheel, wherein the scroll wheel comprises: a plurality of openings, and a plurality of lenses embedded in the plurality of openings separately.

Further, another computer mouse is provided in the present invention. The computer mouse includes at least a scroll wheel, wherein the scroll wheel includes at least a transparent means, while the transparent means includes a plurality of transparent parts and the transparent parts are formed within the transparent means.

These and other features, aspects, and advantages of the present invention will become better understood with reference to the following descriptions, figures, and appended claims.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a diagram of the inner structure of a conventional computer mouse,

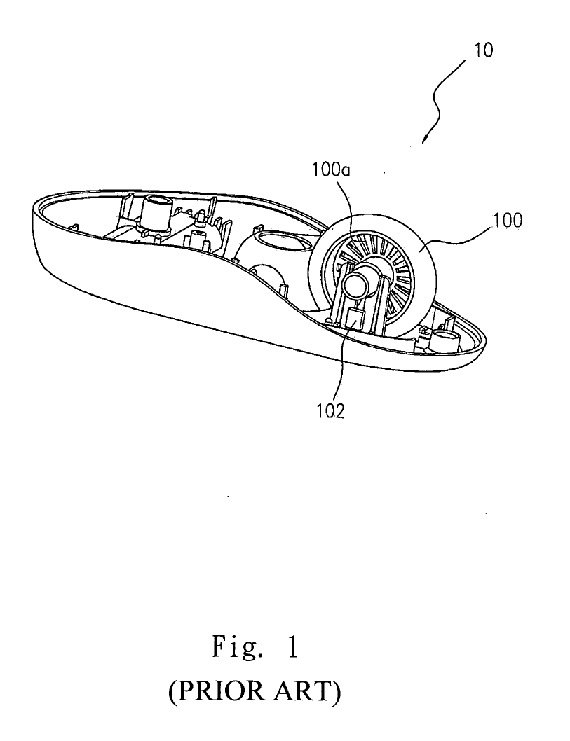

FIG. 2A is a pictorial assembly diagram of the first embodiment of the scroll wheel adopted by the computer mouse of the present invention,

FIG. 2B is a pictorial decomposition diagram of the scroll wheel shown in FIG. 2A,

FIG. 3A is a pictorial assembly diagram of the second embodiment of the scroll wheel adopted by the computer mouse of the present invention,

FIG. 3B is a sectional diagram of the scroll wheel shown in FIG. 3A,

FIG. 4A is a pictorial assembly diagram of the third embodiment of the scroll wheel adopted by the computer mouse of the present invention, and

FIG. 4B is a sectional diagram of the scroll wheel shown in FIG. 4A.

### DESCRIPTION OF THE PREFERRED EMBODIMENTS

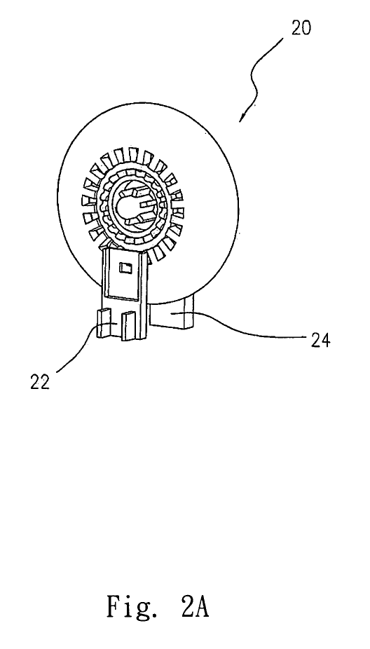

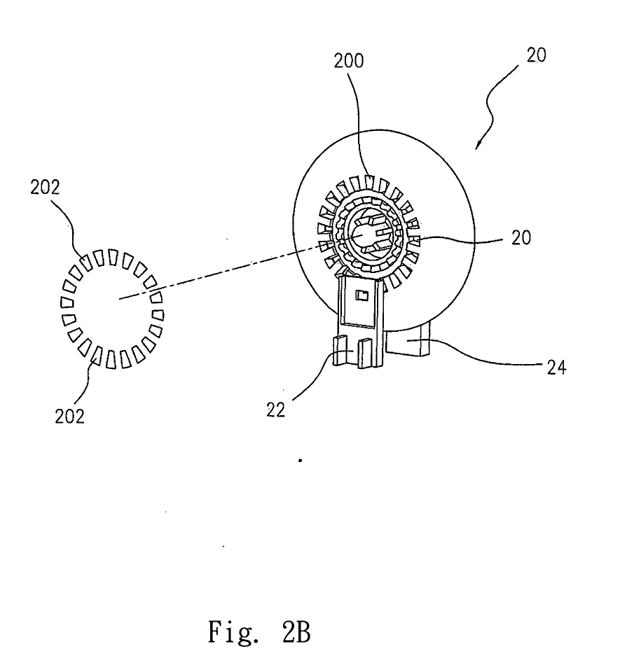

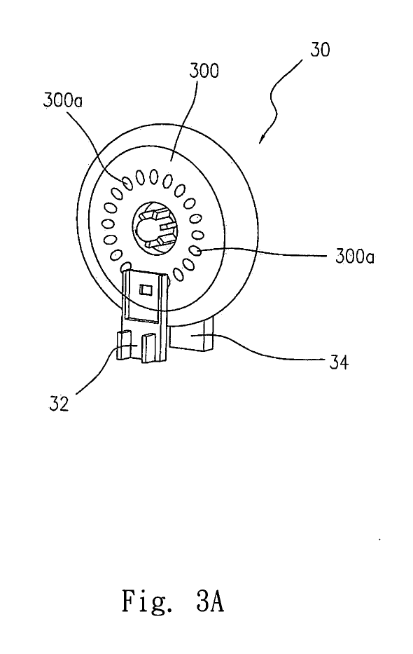

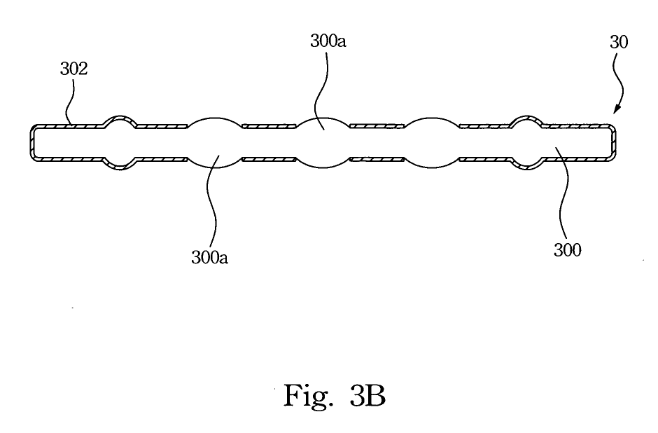

Please refer to FIG. 2A and FIG. 2B. FIG. 2A is a pictorial assembly diagram of the scroll wheel adopted by the computer mouse of the present invention, and FIG. 2B is a pictorial decomposition diagram of the scroll wheel shown in FIG. 2A. The scroll wheel 20 of the present invention, as illustrated in FIG. 2A and FIG. 2B, can be applied in the computer mouse. The scroll wheel 20 includes: a plurality of openings 200, and a plurality of lenses 202, each of which is embedded in one of the openings 200, separately. The openings 202 are formed along an inner circumference of the scroll wheel, and the lenses 202 can be convex lenses (illustrated as the designator 300a of FIG. 3B), for example.

Moreover, the computer mouse of the present invention can further includes a light emitter 22 installed at a side of the scroll wheel. The light emitted by the light emitter 22 can pass through the lenses 202. The light emitter 22 may include a light emitting diode (LED). A light receiver 24 is installed at another side of the scroll wheel 20 for receiving light passing through the lenses 202 and generating corresponding electric signals.

Please refer to FIG. 3A and FIG. 3B. FIG. 3A is a pictorial assembly diagram of the second embodiment of the scroll wheel adopted by the computer mouse of the present invention, and FIG. 3B is a sectional diagram of the scroll wheel shown in FIG. 3A. The scroll wheel 30 of the present invention, displayed in FIG. 3A and FIG. 3B, can be applied in a computer mouse. The scroll wheel 30 includes at least a transparent means 300 with a plurality of transparent parts 300a. Further, the transparent parts 300a are formed on the surface of the transparent means 300 and aligned on the surface of the inner circumference of the transparent means 300. The transparent parts 300a and the transparent means 300 are formed together to bring advantage in fabrication.

The transparent means 300 can adopt a full transparent structure. Otherwise, a surface of the parts other than the transparent parts 300a of the transparent means 300 can be coated with an opaque layer 302, such that the light cannot pass through the parts other than the transparent parts 300a.

Please refer to the sectional diagram of the transparent parts 300a in FIG. 3B. In FIG. 3A and FIG. 3B, each of the transparent parts 300a adopts an convex structure (or lens). It is for sure that structures of other shapes can be adopted by the transparent parts 300a as well. In the sectional view, the transparent parts 300a can adopt a square structure protuberating outward, or a triangle structure protuberating outward, etc.

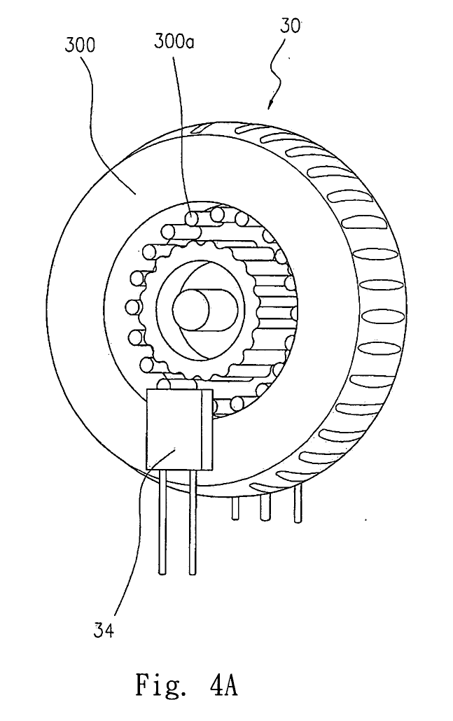

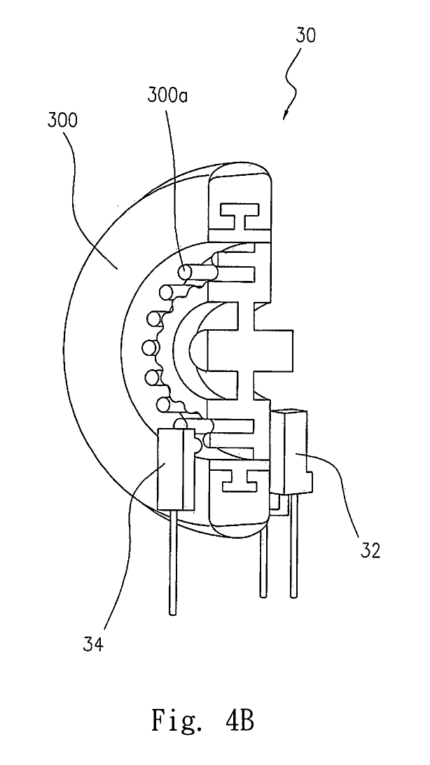

Reference is now made to FIG. 4A and FIG. 4B. FIG. 4A is a pictorial assembly diagram of the third embodiment of the scroll wheel adopted by the computer mouse of the present invention, and FIG. 4B is a sectional diagram of the scroll wheel shown in FIG. 4A. In the third embodiment, a plurality of transparent pillars is adopted by the transparent parts 300a, and the transparent pillars 300a are aligned along an inner circumference of the transparent means 300. The pillars 300a and the transparent means 300 are formed by one to bring advantage in fabrication.

In addition, the computer mouse of the present invention further includes a light emitter installed at a side of the scroll wheel 30, for emitting light to pass through the transparent parts 300a. A light receiver 34 is installed at another side of the scroll wheel 30 for receiving the light passing through the transparent parts 300a and generating corresponding electric signals. The light emitter 32 can comprise an LED, for example.

For the light emitted by the light emitter 22 and 23 focuses when the light passes through the lens 202 and the transparent part 300a, the light strength is enhanced effectively. Hence it becomes easier for the light receiver 24 and 34 to receive the light. Moreover, in the computer mouse of the present invention, the distance between adjacent lenses 202 or adjacent transparent parts 300a can be reduced. That is, the amount of the lenses 202 or the transparent parts 300a on the scroll wheels 20 and 30 are increased. In accordance, the resolution of the encoding signals generated by the scroll wheels 20 and 30 are increased substantially. At the same time, the light receivers 24 and 34 can still receive the light passing through the lens 202 and the transparent parts 300a. Therefore, the correct information of the scroll wheel can be obtained by the computer mouse of the present invention. Hence, the mouse can be precisely controlled by the user.

Although the present invention has been described in considerable detail with reference to certain preferred embodiments thereof, other embodiments are possible. Therefore, their spirit and scope of the appended claims should no be limited to the description of the preferred embodiments contained herein.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A computer mouse comprising at least a scroll wheel, wherein the scroll wheel comprises:
a plurality of openings; and
a plurality of lenses embedded in the plurality of openings separately, wherein light is utilized to pass through the plurality of lenses to generate encoding signals.

2. The computer mouse of claim 1, wherein the lens is a convex lens.

3. The computer mouse of claim 1, wherein the plurality of openings are formed along an inner circumference of the scroll wheel.

4. The computer mouse of claim 1, further comprising a light emitter, installed at a side of the scroll wheel, for emitting light to pass through the plurality of lenses.

5. The computer mouse of claim 4, further comprising a light receiver, installed at another side of the scroll wheel, for receiving light passing through the plurality of lenses and generating corresponding electric signals.

6. The computer mouse of claim 4, wherein the light emitter is a light emitting diode (LED).

7. A computer mouse, comprising at least a scroll wheel, wherein the scroll wheel comprises at least a transparent means, wherein the transparent means comprises a plurality of transparent parts formed within the transparent means and light is utilized to pass through the plurality of transparent parts to generate encoding signals.

8. The computer mouse of claim 7, wherein the transparent parts are formed on a surface of an inner circumference of the transparent means.

9. The computer mouse of claim 7, further comprising a light emitter, installed at a side of the scroll wheel, for emitting light to pass through the lenses.

10. The computer mouse of claim 9, further comprising a light receiver, installed at another side of the scroll wheel, for receiving light passing through the transparent parts.

11. The computer mouse of claim 9, wherein the light emitter is a light emitting diode (LED).

12. The computer mouse of claim 7, wherein the transparent means is a full transparent structure.

13. The computer mouse of claim 7, wherein only the transparent parts of the transparent means are pervious to the light, while the other parts of the transparent means are not pervious to the light.

14. The computer mouse of claim 13, wherein a surface of the other parts of the transparent means is coated with an opaque layer.

15. The computer mouse of claim 7, wherein the transparent parts are a plurality of pillars formed along an inner circumference of the transparent means.
